(19) United States
(12) Patent Application Publication
(10) Pub. No.: US 2026/0184507 A1
(43) Pub. Date: Jul. 2, 2026

(54) GOODS RETRIEVAL AND PLACEMENT DEVICE FOR HIGH-BAY RACK, AND HIGH-BAY RACK

(71) Applicant: SUZHOU MUSHINY INTELLIGENCE TECHNOLOGY CO., LTD, Suzhou, JX (CN)

(72) Inventors: Zhiming HUANG, Suzhou (CN); Fangming ZHONG, Suzhou (CN)

(73) Assignee: SUZHOU MUSHINY INTELLIGENCE TECHNOLOGY CO., LTD, Suzhou, JX (CN)

(21) Appl. No.: 19/166,035

(22) PCT Filed: Dec. 6, 2024
(86) PCT No.: PCT/CN2024/137598

§ 371 Date: Sep. 16, 2025

(30) Foreign Application Priority Data
Jul. 31, 2024 (CN) 202411035773.3

(51) Int. Cl. B65G 1/04; B65G 1/137

(52) U.S. Cl. CPC B65G 1/0492; B65G 1/137; B65G 2203/042

(57) ABSTRACT

The present disclosure relates to the technical field of warehousing and logistics. A goods retrieval and placement device for high-bay rack and a high-bay rack are provided. The goods retrieval and placement device includes a lifting assembly, a traveling assembly arranged on the traveling rail in a movable manner and at least two floating assemblies arranged at intervals along the height direction of the lifting assembly. The floating assembly includes a rigid support and an elastic assembly. The lifting assembly is arranged on the rigid support, and the elastic assembly is arranged between the rigid support and the traveling assembly. According to the technical solution of the present disclosure, when multiple traveling assemblies at different heights are not in the same vertical line, the adaptive change of the distance between the rigid support and the traveling assembly in the vertical direction is realized by the elastic assembly, thereby avoiding the tilt state of the lifting assembly as much as possible and jamming phenomenon between the traveling assembly and the traveling rail. While ensuring that the traveling assembly runs smoothly on the traveling rail, the load capacity of the goods retrieval and placement device is increased.

### FIELD OF THE INVENTION

The present disclosure relates to the technical field of warehousing and logistics, and in particular to a goods retrieval and placement device for high-bay rack, and high-bay rack.

### BACKGROUND OF THE INVENTION

In warehousing and logistics, racks are important facilities for storing goods. They not only provide orderly storage space, but also help improve the warehouse's operating efficiency and space utilization. Existing racks are generally set up as multi-layer structures, and a traveling goods retrieval and placement device is set up on the racks. For example, a goods retrieval and placement device that can move horizontally on the racks is set up. The goods retrieval and placement device includes a lifting track set vertically and a retrieval and placement trolley set on the lifting track. In this way, the retrieval and placement trolley can place the goods at a designated location or retrieve the goods from a designated location by moving horizontally and vertically.

The current racks are relatively high, and correspondingly, the length of the lifting tracks is relatively large, which requires that a plurality of transversely arranged traveling rails be provided on the racks. Thus, when the lifting tracks are moving along the traveling rails, there will be a plurality of traveling assemblies on the traveling rails that are not in the same vertical line, causing the lifting tracks to tilt, and further causing jamming between the traveling assemblies and the traveling rails, which affects the horizontal operation of the lifting tracks.

### SUMMARY OF THE INVENTION

The embodiment of the present disclosure provides a goods retrieval and placement device for high-bay rack, and a high-bay rack, so as to avoid the problem of tilting of the lifting track of the goods retrieval and placement device as much as possible, thereby avoiding the problem of jamming between the traveling assemblies and the traveling rails.

A first aspect of the embodiment of the present disclosure provides a goods retrieval and placement device for high-bay rack, wherein the goods retrieval and placement device is applied to the high-bay rack including a plurality of stacked goods storage areas, and the high-bay rack is provided with at least two horizontally arranged traveling rails, and wherein the goods retrieval and placement device includes: a lifting assembly; a traveling assembly arranged on the traveling rail in a movable manner; and at least two floating assemblies arranged at intervals along the height direction of the lifting assembly, each floating assembly being connected to at least one traveling assembly.

The floating assembly includes a rigid support and an elastic assembly. The lifting assembly is arranged on the rigid support. The elastic assembly is arranged between the rigid support and the traveling assembly. The elastic assembly is configured so that the distance between the rigid support and the traveling assembly can be adaptively changed within a first threshold in the vertical direction.

In one embodiment, the elastic assembly includes an elastic member and a suspension rod. One end of the suspension rod is rotatably fixed on the rigid support, and the other end is connected to the traveling assembly. The elastic member is arranged between the rigid support and the rod body of the suspension rod.

In one embodiment, the elastic member and the traveling assembly are located on the same side of the suspension rod in the vertical direction.

In one embodiment, the elastic assembly further includes an adjustment block, which is disposed between the rigid support and the traveling assembly, and is configured to adjust the value of the first threshold.

In one embodiment, a positioning sensor is provided on the rigid support. The detection end of the positioning sensor faces the traveling rail, and a positioning mark is provided on the side of the traveling rail facing the positioning sensor. The positioning sensor is configured to detect the positioning mark to determine the position coordinates of the rigid support corresponding to the positioning sensor.

In one embodiment, a position limiting assembly is provided on the rigid support. The position limiting assembly can slidably abut against or engage with the traveling rail. The position limiting assembly is configured to limit the distance between the positioning sensor and the positioning mark in the horizontal direction.

In one embodiment, the position limiting assembly includes a first position limiting body and a second position limiting body.

The first position limiting body and the second position limiting body respectively abut against two opposite sides of the running track, and one of the two opposite sides is provided with a positioning mark.

In one embodiment, the position limiting assembly includes a third position limiting body, and a groove for engaging with the third position limiting body is provided on the traveling rail. The groove is used to limit the distance between the positioning sensor and the positioning mark in the horizontal direction.

In one embodiment, the goods retrieval and placement device further includes a first controller electrically connected to the positioning sensor and the traveling assembly.

The first controller is configured to:
obtain the moments when all the positioning sensors detect the positioning marks;
determine the time difference between the positioning sensors of any two floating assemblies detecting the positioning marks, and the sequence of time when all the positioning sensors detect the positioning marks, based on the moments when all positioning sensors detect the positioning marks; and
determine the traveling assembly that needs to be adjusted and the corresponding adjustment amount of traveling speed according to the sequence of time when all the positioning sensors detect the positioning marks, if there is any time difference that is greater than a second threshold.

In one embodiment, the same floating assembly includes two elastic assemblies and is connected to two traveling assemblies, and the two traveling assemblies are respectively arranged at two ends of the rigid support.

In one embodiment, a lidar is provided on the lifting assembly, which is configured to detect point cloud data of the traveling rail with the lidar as a base point.

The goods retrieval and placement device also includes a second controller, which is electrically connected to the lidar and the traveling assembly.

The second controller is configured to:
obtain point cloud data of the traveling rail detected by the lidar;
generate a contour line of the traveling rail according to the point cloud data of the traveling rail;
determine the inclination angle of the contour line of the traveling rail according to the contour line of the traveling rail, based on the horizontal plane where the lidar is located; and
determine the traveling assemblies that need to be adjusted and the corresponding adjustment amount of traveling speed according to the inclination angle of the contour line of the traveling rail.

In one embodiment, the traveling assembly includes a traveling wheel and a first driving mechanism. The traveling wheel is disposed on a traveling rail and connected to an output shaft of the first driving mechanism, and the elastic assembly is connected to the first driving mechanism.

In one embodiment, if multiple traveling assemblies are connected to the same floating assembly, there is at least one traveling assembly that only includes a traveling wheel arranged on traveling rails, and the rotating shaft of the traveling wheel is connected to the floating assembly.

In one embodiment, if the number of floating assemblies is greater than or equal to three, the traveling assembly on at least one floating assembly only includes a traveling wheel arranged on the traveling rail, and the rotating shaft of the traveling wheels is connected to the floating assembly.

In one embodiment, the lifting assembly includes a lifting track, a second driving mechanism, and a goods retrieval and placement platform.

The lifting track is connected to the rigid support. The goods retrieval and placement platform is slidably arranged on the lifting track. The second driving mechanism is connected to the goods retrieval and placement platform, and is configured to drive the goods retrieval and placement platform to move along the lifting track.

A second aspect of the embodiment of the present disclosure provides a high-bay rack comprising a plurality of stacked goods storage areas, at least two horizontally arranged traveling rails are provided on the high-bay rack, and the traveling rails are provided with the goods retrieval and placement device provided by the first aspect of the embodiment of the present disclosure.

The embodiment of the present disclosure provides a goods retrieval and placement device for high-bay rack and a high-bay rack, wherein the goods retrieval and placement device comprises a lifting assembly, a traveling assembly arranged on the traveling rail in a movable manner, and at least two floating assemblies arranged at intervals along the height direction of the lifting assembly, each floating assembly being connected to at least one traveling assembly; the floating assembly comprises a rigid support and an elastic assembly, wherein the lifting assembly is arranged on the rigid support, and the elastic assembly is arranged between the rigid support and the traveling assembly. According to the technical solution of the present disclosure, by providing the elastic assembly, a floating connection is formed between the rigid support and the traveling assembly in the vertical direction. When multiple traveling assemblies at different heights are not in the same vertical line, the adaptive change of the distance between the rigid support and the traveling assembly in the vertical direction is realized by the elastic assembly, thereby avoiding the tilt state of the lifting assembly as much as possible and jamming phenomenon between the traveling assembly and the traveling rail. While ensuring that the traveling assembly runs smoothly on the traveling rail, the load capacity of the goods retrieval and placement device is increased.

### BRIEF DESCRIPTION OF THE DRAWINGS

FIG. 1 is a structural diagram of a high-bay rack provided with a goods retrieval and placement device provided in an embodiment of the present disclosure.

FIG. 2 is a structural diagram of another high-bay rack provided with a goods retrieval and placement device provided in an embodiment of the present disclosure.

FIG. 3 is a structural diagram of the high-bay rack provided in FIG. 2 from another perspective.

FIG. 4 is a structural diagram of a traveling assembly and a floating assembly from a perspective provided in an embodiment of the present disclosure.

FIG. 5 is a structural diagram of a traveling assembly and a floating assembly from another perspective provided in an embodiment of the present disclosure.

FIG. 6 is a diagram of a partial structure of FIG. 3.

FIG. 7 is a structural diagram of a limiting assembly provided in an embodiment of the present disclosure.

FIG. 8 is a structural diagram of a traveling rail provided in an embodiment of the present disclosure.

FIG. 9 is another structural diagram of a traveling rail provided in an embodiment of the present disclosure.

FIG. 10 is a structural diagram of a traveling rail of the high-bay rack provided in an embodiment of the present disclosure.

FIG. 11 is a structural diagram of a goods retrieval and delivery platform provided in an embodiment of the present disclosure.

### DETAILED DESCRIPTION OF THE EMBODIMENTS

In the case of a fixed floor area of the racks, in order to improve the storage capacity of the racks, the height of the racks can be increased. However, after increasing the height of the racks, the length of the lifting track needs to be increased. Accordingly, the length of the lifting track is relatively large, which requires that multiple traveling rails be set on the racks. In this way, when the lifting track moves along the traveling rail, there will be multiple traveling assemblies on the traveling rail that are not on the same vertical line, causing the lifting track to tilt. Moreover, the connection between the traveling assembly and the lifting track is a rigid connection, and the traveling assembly occupies a certain length on the traveling rail, and multiple traveling assemblies are generally arranged on the same traveling rail, and therefore, after the lifting track tilts, multiple traveling assemblies on the same traveling rail will be in a tilted state, so that there will be jamming between the traveling assembly and the traveling rail, causing the traveling assembly to be unable to run smoothly on the traveling rail. In addition, when the lifting track tilts, the heavier the weight of the goods carried on the lifting track, the easier it is to cause the traveling assembly on the traveling rail to be jammed, thereby limiting the load capacity of the goods retrieval and placement device.

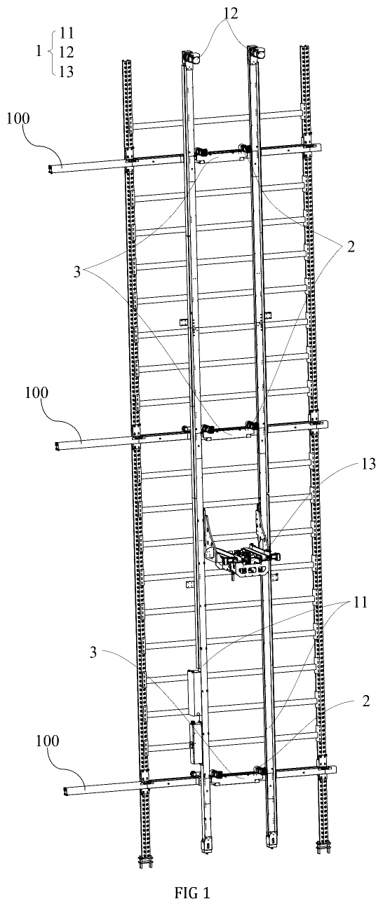

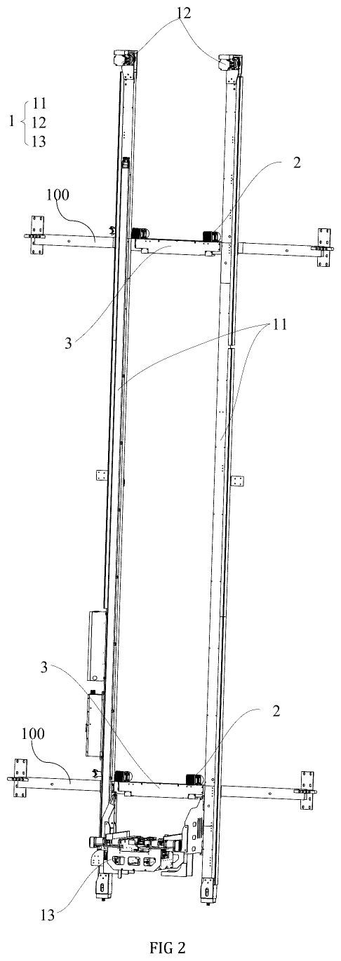

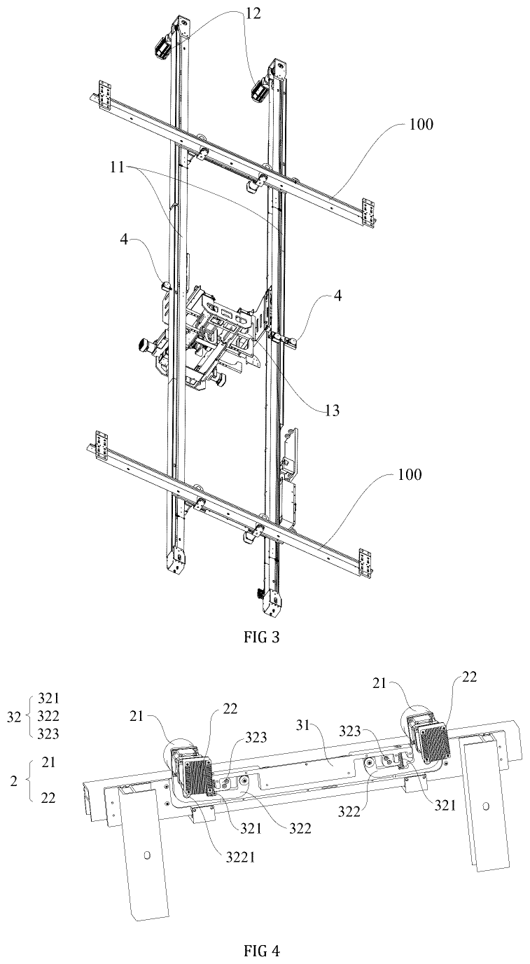

In order to solve the above-mentioned technical problems, the first aspect of an embodiment of the present disclosure provides a goods retrieval and placement device for high-bay rack. As shown in FIGS. 1, 2 and 3, the goods retrieval and placement device should be used on a high-bay rack, wherein the high-bay rack includes a plurality of stacked goods storage areas, and each layer of the goods storage area can be provided with a plurality of compartments, and the goods retrieval and placement device can put the goods into the compartments, or take the goods out of the compartments, and the high-bay rack is provided with at least two horizontally arranged traveling rails 100. For example, as shown in FIGS. 2 and 3, the high-bay rack is provided with two horizontally arranged traveling rails 100, and as shown in FIG. 1, the high-bay rack is provided with three horizontally arranged traveling rails 100.

As shown in FIGS. 1 and 2, the goods retrieval and placement device includes a lifting assembly 1, a traveling assembly 2 and at least two floating assemblies 3. The traveling assembly 2 is arranged to be movable on the traveling rail 100, at least two floating assemblies 3 are arranged at intervals along the height direction of the lifting assembly 1, and each floating assembly 3 is connected to at least one traveling assembly 2, wherein the number of floating assemblies 3 is less than or equal to the number of traveling rails 100.

The floating assembly 3 includes a rigid support 31 and an elastic assembly 32. The lifting assembly 1 is arranged on the rigid support 31. For example, the lifting assembly 1 includes two column structures, and the two column structures are respectively arranged at both ends of the rigid support 31. The elastic assembly 32 is arranged between the rigid support 31 and the traveling assembly 2, and the elastic assembly 32 is configured such that the distance between the rigid support 31 and the traveling assembly 2 can be adaptively changed within a first threshold in the vertical direction.

Specifically, a cavity structure is provided in the rigid support 31, and the elastic assembly 32 is arranged in the cavity. In order to realize that the distance between the rigid support 31 and the traveling assembly 2 can be adaptively changed within the first threshold, in actual application, the elastic assembly 32 is configured such that the direction of the elastic force of the elastic assembly 32 is the vertical direction, or the elastic force has a component in the vertical direction. As a result, a floating connection is formed between the traveling assembly 2 and the lifting assembly 1. That is, in the vertical direction, the traveling assembly 2 abuts against the traveling rail 100, and when multiple traveling assemblies 2 at different heights are not in the same vertical line, the elastic assembly 32 is used to realize the adaptive change of the distance between the rigid support 31 and the traveling assembly 2 in the vertical direction, so as to avoid as much as possible the lifting assembly 1 from being tilted, and further avoid the traveling assembly 2 and the traveling rail 100 from being jammed. At the same time, while ensuring that the traveling assembly 2 runs smoothly on the traveling rail 100, the load capacity of the goods retrieval and placement device is increased.

The embodiment of the present disclosure provides a goods retrieval and placement device for high-bay rack, comprising a lifting assembly 1, a traveling assembly 2 and at least two floating assemblies 3. The traveling assembly 2 is arranged to be movable on the traveling rail 100, at least two floating assemblies 3 are arranged at intervals along the height direction of the lifting assembly 1, and each floating assembly 3 is connected to at least one traveling assembly 2. The floating assembly 3 comprises a rigid support 31 and an elastic assembly 32. The lifting assembly 1 is arranged on the rigid support 31, and the elastic assembly 32 is arranged between the rigid support 31 and the traveling assembly 2. According to the solution provided by the embodiment of the present disclosure, a floating connection is formed between the rigid support 31 and the traveling assembly 2 in the vertical direction by arranging the elastic assembly 32, thereby avoiding the phenomenon of jamming between the traveling assembly 2 and the traveling rail 100 due to the tilt of the lifting assembly 1 when the traveling assembly 2 is rigidly connected to the lifting assembly 1.

In some embodiments of the present disclosure, as shown in FIG. 4, the elastic assembly 32 includes an elastic member 321 and a suspension rod 322, one end of the suspension rod 322 is rotatably fixed on the rigid support 31, and the other end is connected to the traveling assembly 2. The elastic member 321 is arranged between the rigid support 31 and the rod body of the suspension rod 322. Specifically, as shown in FIG. 4, a notch for engaging with the elastic member 321 is arranged on the suspension rod 322, and the elastic member 321 and the traveling assembly 2 are on the same side in the vertical direction of the suspension rod 322, so that the elastic member 321 is in a compressed state. The elastic member 321 in the compressed state can effectively absorb the vibration and impact energy generated by the traveling assembly 2 during traveling. Of course, in actual application, the elastic member 321 and the traveling assembly 2 can also be arranged on different sides in the vertical direction of the suspension rod 322, so that the elastic member 321 is in a tensioned state. In the embodiment of the present disclosure, preferably, the elastic member 321 is arranged in the compressed state, and specifically, the elastic member 321 can be arranged as a spring.

In some embodiments of the present disclosure, the suspension rod 322 and the elastic member 321 are used. By setting the elastic member 321 in the middle area of the rod body of the suspension rod 322, the suspension rod 322 and the elastic member 321 can form a lever structure. In this way, the value of the first threshold can be effectively increased. Of course, in actual application, the elastic assembly 32 can also be provided with the elastic member 321 only, and the elastic member 321 can be directly set between the rigid support 31 and the traveling assembly 2.

As shown in FIG. 4, a guide groove 3221 is also provided on the suspension rod 322, wherein a position limiting rod is fixedly provided on the rigid support 31, and the position limiting rod is located in the guide groove 3221, so that when the suspension rod 322 moves in the vertical direction, the movement stability of the suspension rod 322 is ensured through the cooperation between the guide groove 3221 and the position limiting rod.

As shown in FIG. 4, the elastic assembly 32 further includes an adjustment block 323, which is disposed between the rigid support 31 and the traveling assembly 2. In this way, the value of the first threshold can be adjusted by mounting the adjustment blocks 323 of different sizes in the vertical direction. Of course, if necessary, the value of the first threshold can be adjusted to 0 by the adjustment block 323. As a result, the connection relationship between the rigid support 31 and the traveling assembly 2 is converted between a rigid connection and a floating connection, thereby forming a compatible design. In actual application, the suspension rod 322 may not be provided, while the elastic member 321 may be directly provided between the rigid support 31 and the traveling assembly 2.

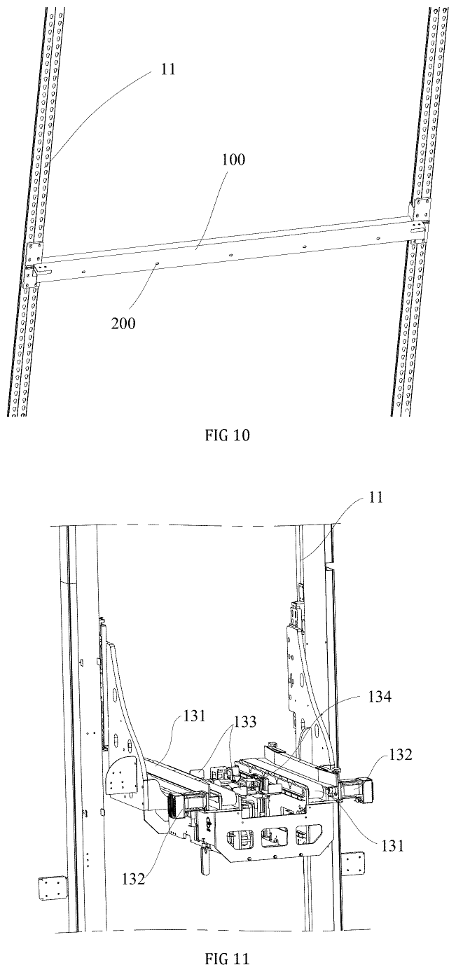

As shown in FIG. 5, in some embodiments of the present disclosure, a positioning sensor 33 is provided on the rigid support 31, and the detection end of the positioning sensor 33 faces the traveling rail 100. As shown in FIGS. 5 and 10, a positioning mark 200 is provided on the side of the traveling rail 100 facing the positioning sensor 33, and the positioning sensor 33 is configured to detect the positioning mark 200. In this way, when the traveling assembly 2 moves along the traveling rail 100, the positioning mark 200 is detected by the positioning sensor 33, thereby determining the position coordinates of the positioning sensor 33, that is, determining the position coordinates of the rigid support 31 on which the positioning sensor 33 is provided.

On this basis, the goods retrieval and placement device further includes a first controller, which is electrically connected to the positioning sensor 33 and the traveling assembly 2, and is configured to execute steps S101 to S103.

Step S101, obtaining the moments when all positioning sensors 33 detect the positioning mark 200.

In the embodiment of the present disclosure, a positioning sensor 33 is provided on one rigid support 31, and a plurality of positioning marks 200 are provided on the traveling rail 100, and the plurality of positioning marks 200 are equidistantly arranged. For example, the distance between two adjacent positioning marks 200 is 500 mm. The positioning marks 200 on the plurality of traveling rails 100 are coaxially arranged in the vertical direction, ensuring that the positioning marks 200 detected by all positioning sensors 33 within a preset time are on the same vertical line. The positioning mark 200 can be designed as a hole-type structure, and correspondingly, the positioning sensor 33 is a photoelectric sensor, so that when the detection end of the positioning sensor 33 is aligned with the hole-type structure, the detection signal of the photoelectric sensor changes, thereby determining that the positioning sensor 33 is at the position of the positioning mark 200. It should be noted that the cross-sectional area of the hole-type structure is larger than the detection area of the positioning sensor 33 on the traveling rail 100, so that when the rigid support 31 is tilted, the hole-type structure is still within the detection range of the positioning sensor 33.

Step S102, determining the time difference between the positioning sensors 33 of any two floating assemblies 3 detecting the positioning marks 200, and the sequence of time when all the positioning sensors 33 detect the positioning marks 200, based on the moments when all the positioning sensors 33 detect the positioning mark 200.

When multiple traveling assemblies 2 at different heights are not in the same vertical line, since the lifting assembly 1 is a rigid structure, in actual application, it is also possible to determine only the time difference between the two positioning sensors 33 detecting the positioning mark 200. The two sensors 33 are respectively the two positioning sensors 33 at the highest and lowest heights in the vertical direction. Among them, taking the advancing direction of the traveling assembly 2 as the forward direction, the positioning sensor 33 that first detects the positioning mark 200 is located more forward.

Step S103, determining the traveling assembly 2 that needs to be adjusted and the corresponding adjustment amount of traveling speed according to the sequence of the time when all the positioning sensors 33 detect the positioning marks 200, if there is any time difference that is greater than a second threshold.

When determining the traveling assembly 2 that needs to be adjusted, the traveling assembly 2 at the front position can be adjusted. For example, the traveling speed of the traveling assembly 2 at the front position is reduced, and it continues for a preset time. The traveling assembly 2 at the back position can also be adjusted, for example, the traveling speed of the traveling assembly 2 at the back position is increased, and it continues for a preset time. In actual application, due to the constraints of the overall structure of the goods retrieval and placement device, the positions of multiple traveling assemblies 2 in the horizontal direction will not differ greatly. Therefore, when adjusting the speed of the traveling assembly 2, a slight adjustment is selected, and after the adjustment, the positioning sensor 33 is used again to detect the positioning mark 200. During the horizontal movement of the lifting assembly 1, the relative positions of the multiple traveling assemblies 2 are repeatedly corrected, so as to prevent the lifting assembly 1 from being tilted as much as possible.

In order to control the distance between the positioning sensor 33 and the positioning mark 200 in the horizontal direction to ensure the detection accuracy of the positioning sensor 33, in an embodiment of the present disclosure, a position limiting assembly 34 is provided on the rigid support 31. The position limiting assembly 34 may abut against or engage with the traveling rail 100 in a sliding manner, so that when the position limiting assembly 34 moves with the rigid support 31, the distance between the positioning sensor 33 and the positioning mark 200 in the horizontal direction is controlled by limiting the positioning sensor 33 from approaching or moving away from the traveling rail 100 in the horizontal direction.

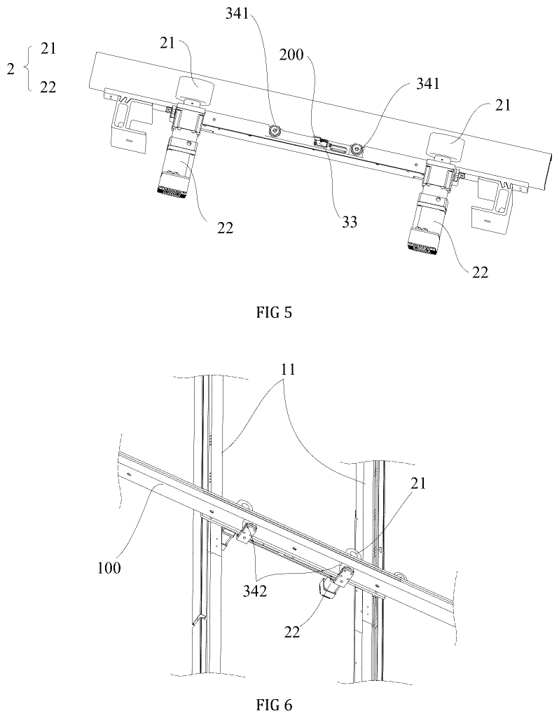

For example, the position limiting assembly 34 includes a first position limiting body 341 and a second position limiting body 342. As shown in FIG. 5, the rigid support 31 is provided with a first position limiting body 341 abutting against the traveling rail 100. As shown in FIG. 6, the rigid support 31 is provided with a second position limiting body 342 abutting against the traveling rail 100. That is, the first position limiting body 341 and the second position limiting body 342 respectively abut against the opposite sides of the traveling rail 100, and one of the opposite sides is provided with a positioning mark 200. In this way, the position limiting assembly 34 that is engaged on the traveling rail 100 is formed by the first position limiting body 341 and the second position limiting body 342, thereby limiting the positioning sensor 33 from approaching or moving away from the traveling rail in the horizontal direction. The first position limiting body 341 and the second position limiting body 342 can be sliders or rollers.

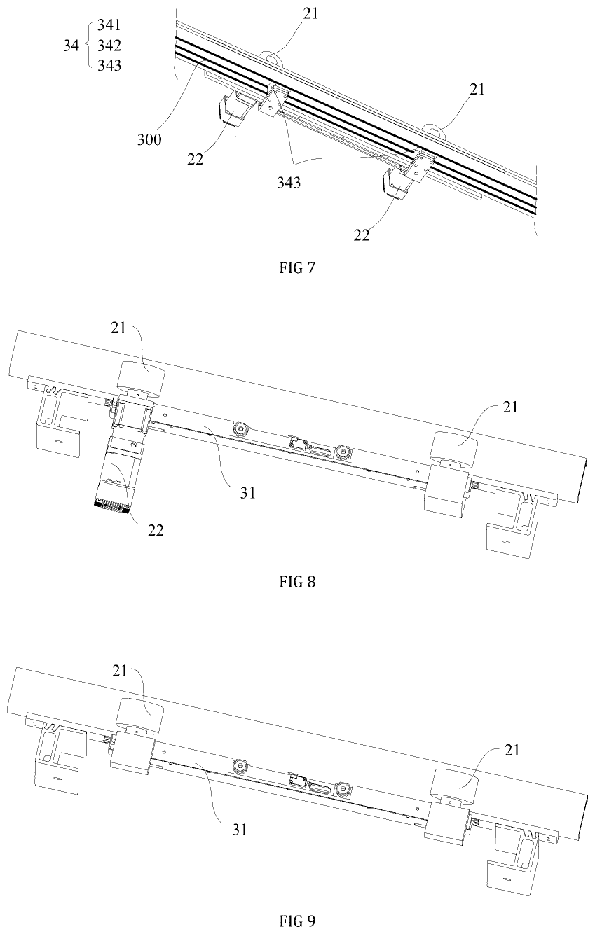

For another example, as shown in FIG. 7, the position limiting assembly 34 includes a third position limiting body 343. A groove 300 for engaging the third position limiting body 343 is provided on the traveling rail 100, and the groove 300 is used to limit the horizontal distance between the positioning sensor 33 and the positioning mark 200. In this way, the position limiting assembly 34 is engaged in the groove 300, thereby limiting the positioning sensor 33 from approaching or moving away from the traveling rail 100 in the horizontal direction.

As shown in FIG. 4, in some embodiments of the present disclosure, the same floating assembly 3 includes two elastic assemblies 32, and the same floating assembly 3 is connected to two traveling assemblies 2. The two traveling assemblies 2 are respectively arranged at both ends of the rigid support 211. It should be noted that when multiple traveling assemblies 2 at different heights are not in the same vertical line, in the vertical direction, the distances between the same floating assembly 3 and the two traveling assemblies 2 are not equal. That is, through the action of the elastic assembly 32, the rolling cooperation between the two traveling assemblies 2 and the traveling rail 100 is effectively guaranteed. At this time, the rigid support 31 is in an inclined state, so as to prevent the lifting assembly 1 from tilting as much as possible.

Since the positioning mark 200 is arranged at intervals, there is a certain time interval when the position detection is performed on multiple traveling assemblies 2 at different heights. In addition, when the multiple traveling assemblies 2 are not in the same vertical line and the position difference in the horizontal direction is small, the lifting assembly 1 can still be in a vertical state due to the action of the floating assembly 3. On this basis, in order to realize the real-time detection of the tilt state of the lifting assembly 1, especially the real-time detection of the tilt state of the lifting assembly 1 when the traveling rail 100 is a linear track, as shown in FIG. 3, a lidar 4 is arranged on the lifting assembly 1. The lidar 4 is configured to detect the point cloud data of the traveling rail 100 with the lidar 4 as the base point. The lidar 4 is arranged on the column of the lifting assembly 1, preferably in the middle area of the column, that is, when the lifting assembly 1 is in a vertical state, the lidar 4 is at an equal distance from the traveling rails 100 on the upper and lower sides. The number of lidars 4 installed is related to the number of traveling rails 100, and it is necessary to ensure that a lidar 4 is arranged between any two traveling rails 100.

The goods retrieval and placement device further includes a second controller, which is electrically connected to the lidar 4 and the traveling assembly 2. In actual application, the first controller and the second controller can be different units of the same device or different devices. The second controller is configured to execute steps S201 to S204.

Step S201, obtaining point cloud data of the traveling rail 100 detected by the lidar 4.

After acquiring the point cloud data of the traveling rail 100, necessary point cloud data processing is also performed, including, for example, point cloud data preprocessing, wherein the original lidar point cloud data is denoised and filtered to improve data quality. Another example is point cloud data downsampling, wherein the point cloud data is downsampled, key points are retained or voxel processing is performed, in order to reduce the amount of calculation.

Step S202, generating a contour line of the traveling rail 100 according to the point cloud data of the traveling rail 100.

Generating the contour line of the traveling rail 100 also includes necessary generation means, for example, contour extraction, wherein potential contour lines are extracted through a clustering algorithm according to the density, curvature or other geometric features of the point cloud data. Another example is contour fitting, wherein the extracted contour point cloud data can be fitted through a mathematical model to form smooth contour lines. Still another example is contour optimization, wherein the extracted contour lines are further refined by resampling, smoothing or using a more complex mathematical model to eliminate noise or undesirable curvature.

Step S203, determining the inclination angle of the contour line of the traveling rail 100 according to the contour line of the traveling rail 100, based on the horizontal plane where the lidar 4 is located.

It should be noted that since the lifting track 11 is the track of the high-bay rack, the height of the lifting track 11 is relatively high. For example, the height of the lifting track 11 is usually greater than 10 m, and the loaded goods retrieval and placement platform 13 will rise and fall on the lifting track 11, causing the lifting track 11 to deform to a certain extent, resulting in the contour lines of the two traveling rails detected by the lidar 4 to be non-parallel. In actual application, it is only necessary to fit the inclination direction of the traveling rail 100 and the inclination angle of a preset accuracy according to the contour lines of the two traveling rails 100.

Step S204, determining the traveling assembly 2 that needs to be adjusted and the corresponding adjustment amount of traveling speed according to the inclination angle of the contour line of the traveling rail 100.

According to the technical solution provided in the embodiment of the present disclosure, the inclination angle of the traveling rail 100 relative to the horizontal plane is detected in real time by the lidar 4 and the second controller. Therefore, the posture of the lifting assembly 1 is corrected in real time by controlling the traveling speed of multiple traveling assemblies 2. As shown in FIGS. 4 and 5, in some embodiments of the present disclosure, the traveling assembly 2 includes a traveling wheel 21 and a first driving mechanism 22. The traveling wheel 21 is arranged on the traveling rail 100, and is connected to the output shaft of the first driving mechanism 22. The elastic assembly 32 is connected to the first driving mechanism 22.

The first driving mechanism 22 includes a motor and a reducer. In actual application, when multiple traveling assemblies 2 are arranged on the same rigid support 31, the multiple traveling assemblies 2 can be driven by a single motor, that is, the multiple traveling assemblies 2 are driven by one motor. Alternatively, the multiple traveling assemblies 2 can be driven by multiple motors, that is, each traveling assembly 2 is provided with an independent motor for driving.

In some embodiments of the present disclosure, if there are multiple traveling assemblies 2 connected to the same floating assembly 3, some of the traveling assemblies 2 can be set to a non-powered structure, wherein the non-powered structure means that the traveling assembly 2 itself does not provide power for traveling. That is, as shown in FIG. 8, there is at least one traveling assembly 2 that only includes a traveling wheel 21, and the traveling wheel 21 is arranged on the traveling rail 100. The rotating shaft of the traveling wheel 21 is connected to the floating assembly 3, that is, the traveling assembly 2 is a driven structure, and during the horizontal movement of the goods retrieval and placement device, it moves along the traveling rail 100 in a rolling manner to follow the floating assembly 3.

In addition, if the number of floating assemblies 3 is greater than or equal to 3, the traveling assembly 2 in the middle of the vertical height can be set as a non-powered structure. That is, as shown in FIG. 9, at least one traveling assembly 2 on the floating assembly 3 only includes a traveling wheel 21 provided on the traveling rail 100, and the rotating shaft of the traveling wheel 21 is connected to the floating assembly 3.

It should be noted that the above-mentioned traveling assembly 2 only includes the traveling wheel 21, which means that the traveling assembly 2 does not include a driving motor, thereby forming a traveling assembly without a power mechanism. In this way, the resistance of the horizontal traveling of the goods retrieval and placement device can be reduced while improving the power utilization rate of the goods retrieval and placement device.

As shown in FIGS. 1, 2 and 3, in some embodiments of the present disclosure, the lifting assembly 1 includes a lifting track 11, a second driving mechanism 12 and a goods retrieval and placement platform 13. The lifting track 11 is connected to the rigid support 31. The goods retrieval and placement platform 13 is slidably arranged on the lifting track 11. The second driving mechanism 12 is connected to the goods retrieval and placement platform 13, and is configured to drive the goods retrieval and placement platform 13 to move along the lifting track 11.

The second driving mechanism 12 includes a power device and a transmission device. For example, the power device includes a motor and a reducer cooperating with each other. The transmission device includes a synchronous belt and a pulley cooperating with each other, or a drive chain and a sprocket.

As shown in FIG. 11, the goods retrieval and placement platform 13 includes a conveyor belt 131, a conveyor belt drive motor 132, a bidirectional hook 133, a fork lift mechanism 134, and a hook traveling mechanism. The conveyor belt 131 is arranged on a transmission wheel connected by the conveyor belt drive motor 132, and is used to transport the goods to the goods retrieval and placement platform 13, or unload the goods from the goods retrieval and placement platform 13. The bidirectional hook 133 is connected to the fork lift mechanism 134 and the hook traveling mechanism, so as to control the bidirectional hook 133 to rise and fall through the fork lift mechanism 134, and control the bidirectional hook 133 to move horizontally through the hook traveling mechanism. The bidirectional hook 133 is used to pick up and/or fix the goods.

The second aspect of an embodiment of the present disclosure provides a high-bay rack. As shown in FIGS. 1 and 2, the high-bay rack includes a plurality of stacked goods storage areas, and at least two horizontally arranged traveling rails 100 are provided on the high-bay rack. The traveling rails 100 are provided with the goods retrieval and placement device provided by the first aspect of the embodiment of the present disclosure.

The embodiment of the present disclosure provides a goods retrieval and placement device for high-bay rack, comprising: a lifting assembly 1, a traveling assembly 2 arranged on a traveling rail 100 and at least two floating assemblies 3 arranged at intervals along the height direction of the lifting assembly 1, each floating assembly 3 being connected to at least one traveling assembly 2. The floating assembly 3 comprises a rigid support 31 and an elastic assembly 32. The lifting assembly 1 is arranged on the rigid support 31, and the elastic assembly 32 is arranged between the rigid support 31 and the traveling assembly 2. According to the technical solution of the present disclosure, by providing the elastic assembly 32, a floating connection is formed between the rigid support 31 and the traveling assembly 2 in the vertical direction. When multiple traveling assemblies 2 at different heights are not in the same vertical line, the adaptive change of the distance between the rigid support 31 and the traveling assembly 2 in the vertical direction is realized by the elastic assembly 32, thereby avoiding the tilt state of the lifting assembly 1 as much as possible and jamming phenomenon between the traveling assembly 2 and the traveling rail 100. While ensuring that the traveling assembly 2 runs smoothly on the traveling rail 100, the load capacity of the goods retrieval and placement device is increased.

1. A goods retrieval and placement device for high-bay rack, applied to the high-bay rack comprising a plurality of stacked goods storage areas and being provided with at least two horizontally arranged traveling rails, wherein the goods retrieval and placement device comprises: a lifting assembly; a traveling assembly arranged on the traveling rail in a movable manner; and at least two floating assemblies arranged at intervals along the height direction of the lifting assembly, each floating assembly being connected to at least one traveling assembly;
wherein the floating assembly comprises a rigid support and an elastic assembly, the lifting assembly is arranged on the rigid support, the elastic assembly is arranged between the rigid support and the traveling assembly, and the elastic assembly is configured so that the distance between the rigid support and the traveling assembly can be adaptively changed within a first threshold in the vertical direction;
wherein the rigid support is provided with a positioning sensor, a detection end of the positioning sensor faces the traveling rail, and a positioning mark is provided on a side of the traveling rail facing the positioning sensor, and the positioning sensor is configured to detect the positioning mark to determine the position coordinates of the rigid support corresponding to the positioning sensor;
wherein the goods retrieval and placement device further comprises a first controller electrically connected to the positioning sensor and the traveling assembly;
wherein the first controller is configured to:
obtain the moments when all the positioning sensors detect the positioning marks (200);
determine the time difference between the positioning sensors of any two floating assemblies detecting the positioning mark, and the sequence of time when all the positioning sensors detect the positioning marks, based on the moments when all the positioning sensors detect the positioning marks; and
determine the traveling assembly that needs to be adjusted and the corresponding adjustment amount of traveling speed according to the sequence of time when all the positioning sensors detect the positioning marks, if there is any time difference that is greater than a second threshold.

2. The goods retrieval and placement device for high-bay rack according to claim 1, wherein the elastic assembly comprises an elastic member and a suspension rod, one end of the suspension rod is rotatably fixed on the rigid support, and the other end is connected to the traveling assembly, and the elastic member is arranged between the rigid support and the rod body of the suspension rod.

3. The goods retrieval and placement device for high-bay rack according to claim 2, wherein the elastic assembly further comprises an adjustment block disposed between the rigid support and the traveling assembly, and the adjustment block is configured to adjust the value of the first threshold.

4. (canceled)

5. The goods retrieval and placement device for high-bay rack according to claim 1, wherein a position limiting assembly is provided on the rigid support, and the position limiting assembly can slidably abut against or engage with the traveling rail, and is configured to limit the distance between the positioning sensor and the positioning mark in the horizontal direction;
wherein the position limiting assembly comprises a first position limiting body and a second position limiting body respectively abutting against two opposite sides of the traveling rail, and one of the two opposite sides is provided with the positioning mark; or
the position limiting assembly comprises a third position limiting body, and the traveling rail is provided with a groove for engaging the third position limiting body, and the groove is used to limit the distance between the positioning sensor and the positioning mark in the horizontal direction.

6. (canceled)

7. The goods retrieval and placement device for high-bay rack according to claim 1, wherein a lidar is provided on the lifting assembly for detecting point cloud data of the traveling rail with the lidar as a base point;
wherein the goods retrieval and placement device further comprises a second controller electrically connected to the lidar and the traveling assembly;
wherein the second controller is configured to:
obtain point cloud data of the traveling rail detected by the lidar;
generate a contour line of the traveling rail according to the point cloud data of the traveling rail;
determine the inclination angle of the contour line of the traveling rail according to the contour line of the traveling rail, based on the horizontal plane where the lidar is located; and
determine the traveling assemblies that need to be adjusted and the corresponding adjustment amount of traveling speed according to the inclination angle of the contour line of the traveling rail.

8. The goods retrieval and placement device for high-bay rack according to claim 1, wherein the traveling assembly comprises a traveling wheel and a first driving mechanism, the traveling wheel is disposed on the traveling rail and connected to an output shaft of the first driving mechanism, and the elastic assembly is connected to the first driving mechanism.

9. The goods retrieval and placement device for high-bay rack according to claim 1, wherein, if multiple traveling assemblies are connected to the same floating assembly, there is at least one traveling assembly that only includes a traveling wheel arranged on the traveling rail, and a rotating shaft of the traveling wheel is connected to the floating assembly.

10. The goods retrieval and placement device for high-bay rack according to claim 1, wherein, if the number of the floating assemblies is greater than or equal to three, the traveling assembly on at least one floating assembly only includes a traveling wheel arranged on the traveling rail, and a rotating shaft of the traveling wheel is connected to the floating assembly.

11. The goods retrieval and placement device for high-bay rack according to claim 1, wherein the lifting assembly comprises a lifting track, a second driving mechanism and a goods retrieval and placement platform;
wherein the lifting track is connected to the rigid support, the goods retrieval and placement platform is slidably arranged on the lifting track, and the second driving mechanism is connected to the goods retrieval and placement platform, and is configured to drive the goods retrieval and placement platform to move along the lifting track.

12. A high-bay rack, comprising a plurality of stacked goods storage areas, wherein at least two horizontally arranged traveling rails are provided on the high-bay rack, and the goods retrieval and placement device for high-bay rack according to claim 1 is provided on the traveling rail.
